(19) United States
(12) Patent Application Publication
(10) Pub. No.: US 2005/0107129 A1
(43) Pub. Date: May 19, 2005

(54) Environment-aware call annunciator

(75) Inventors: Brian J. Kaewell, Jamison, PA (US); John David Kaewell JR., Jamison, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/747,430

(22) Filed: Dec. 29, 2003

Related U.S. Application Data
(60) Provisional application No. 60/519,685, filed on Nov. 13, 2003.

(51) Int. Cl. H04B 1/38

(52) U.S. Cl. 455/567

(57) ABSTRACT

A call annunciator is to be selected for use with a wireless transmit/receive unit (WTRU). The WTRU receives environmental input and categorizes the environmental input into one of a plurality of categories. Based on the one environmental input category, a call annunciator type is selected out of a plurality of call annunciator types. A received call is annunciated using the selected call annunciator type.

### CROSS REFERENCE TO RELATED APPLICATION(S)

This application claims priority from U.S. provisional application No. 60/519,685 filed on Nov. 13, 2003, which is incorporated by reference as if fully set forth.

### FIELD OF INVENTION

This invention relates to wireless devices, and more particularly to call annunciators for wireless devices.

### BACKGROUND

Present cell phones are manually configured by their users for a particular call annunciator mode, such as silent, low volume and high volume. Thus, if a user has the phone set for a low volume ring in a quiet environment and moves to a noisy environment, the ring will be difficult to hear. Conversely, it may be undesirable to have a loud ring in a quiet environment.

Some cellular telephones are able to be set to different call annunciator modes, for example normal volume ring, high volume ring and quiet annunciators (such as by vibration or lights). In one configuration, the user presses a button, and either operates a menu or sequentially presses the button in order to change annunciator modes. Thus, if the user is entering a concert or restaurant, the user can change the annunciator to vibrate, and when stepping into a high noisy environment, can change the annunciator a loud volume ringer setting. The disadvantage of such a system is that it relies on the user remembering to make the changes, and requires the user to actively operate the cellular telephone's programming function in accordance with the user's movements.

Accordingly, it is desirable to have alternate call annunciator controls.

### SUMMARY

A call annunciator is to be selected for use with a wireless transmit/receive unit (WTRU). The WTRU receives environmental input and categorizes the environmental input into one of a plurality of categories. Based on the one environmental input category, a call annunciator type is selected out of a plurality of call annunciator types. A received call is annunciated using the selected call annunciator type.

### BRIEF DESCRIPTION OF THE DRAWING(S)

FIGS. 1A and 1B are simplified block diagrams of environment-aware call annunciators.

FIG. 2 is a flow diagram of an embodiment for environment-aware call annunciators.

FIG. 3 is a flow diagram of an embodiment for environment-aware call annunciators using call information.

### DETAILED DESCRIPTION OF THE PREFERRED EMBODIMENT(S)

A wireless transmit/receive unit (WTRU) includes but is not limited to a user equipment (UE) such as a cellular telephone, mobile station, fixed or mobile subscriber unit, pager, or any other type of device capable of operating in a wireless environment. These exemplary types of wireless environments include, but are not limited to, wireless local area networks (WLANs) and public land mobile networks. A base station includes but is not limited to a base station, Node B, site controller, access point or other interfacing device in a wireless environment.

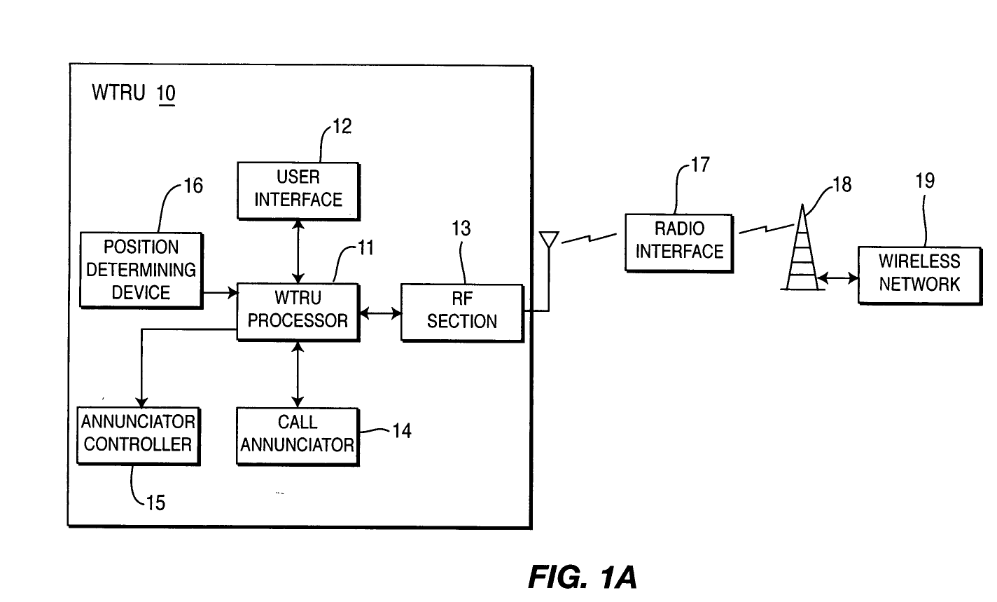

FIGS. 1A and 1B are schematic block diagrams of embodiments for an environment-aware call annunciator system. In FIG. 1A, the WTRU 10 includes an RF section 13, a WTRU processor 11, a user interface 12, a call annunciator 14 and an annunciator controller 15. The RF section 13 receives and transmits wireless signals, such as those in a Bluetooth, WLAN or cellular format. The WTRU processor 11 performs various signal and application processing for the WTRU 10. The WTRU processor 11 may be a single processor or multiple processors, such as an application processor and a digital signal processor (DSP). The annunciator 14 may include a ringer with various volume and ringer sound choices, a vibrator, a lights and/or other annunciator types. The annunciator controller 15 may be a function performed by the WTRU processor 11 or a separate component as illustrated in FIGS. 1A and 1B, respectively. Additionally, the WTRU 10 includes a user interface 12 for interaction with the user. Many user interface variants may be used, such as various combinations of a keypad, LCD display, touchscreen display, a microphone, lights, speaker, etc. In some WTRUs 10, a position determining device 16 may be used. The types of position determining devices 16 include global positioning system and cellular based systems. These components of the WTRU 10 may be implemented on a single integrated circuit (IC), multiple ICs and/or as discrete components.

The WTRU 10 is linked to a wireless network 19, via a radio interface 17 and one or more base stations 18. In an ad hoc network, the WTRU 10 may be connected to the network 19, via other WTRUs.

In FIG. 1B, some of the processing is network based. The network includes a processor 20 for performing various functions and the annunciator controller 21. This configuration allows for a reduction in some of the power consuming processing of the WTRU 10. The WTRU processing and annunciator control function may also be distributed between the WTRU 10 and wireless network 19.

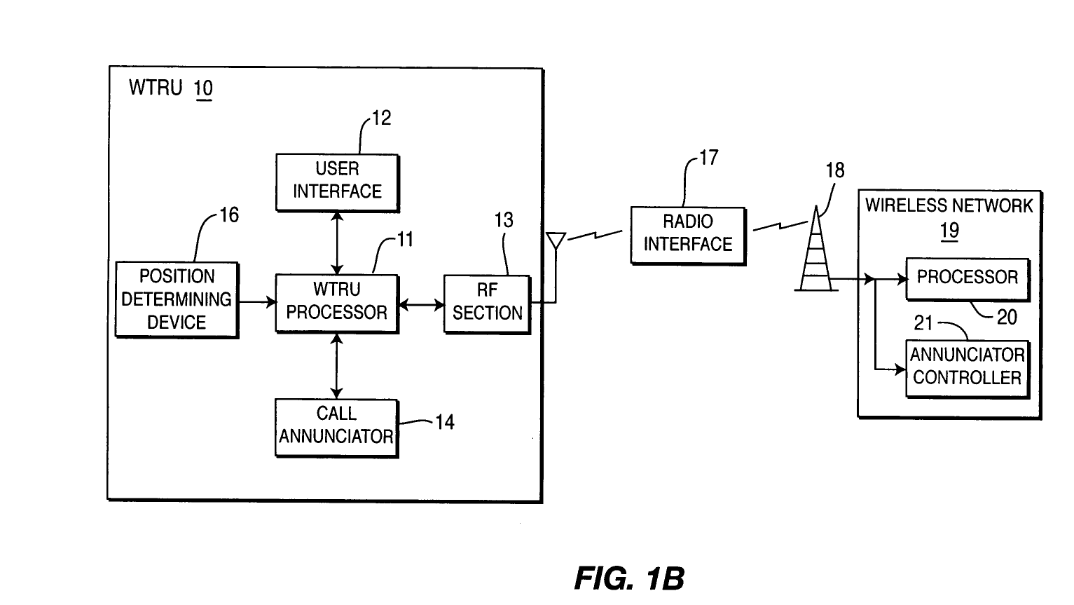

FIG. 2 is a flow diagram of an embodiment of an environment-aware call annunciator system. Initially, the WTRU receives an environmental input, (step 30). One potential environmental input uses a microphone of the user interface or, alternately, a separate microphone. The microphone produces an audio signal of the sound around the WTRU 10.

The WTRU processor 11 analyzes these sounds, such as by measuring an average ambient volume level. An average ambient volume level is an indicator that the WTRU 10 is in a quiet, moderately noisy, or extremely noisy environment. Other ambient sound characteristics include audio frequency, frequency of volume level changes, frequency of occurrence of sounds of a predetermined characteristics, and presence of sounds of particular characteristics. The WTRU processor 11, in some embodiments, identifies a type of the noise, such as whether the noise is voice based, mechanical (such as due to machinery) or music. To determine whether the sound is voice based, voice recognition hardware/software already available for other features (such as voice activated dialing) may be used.

Additional environmental information may be indicated by the positioning device 16. A location map can be utilized to determine whether the individual's location is within a building (indoors and outdoors) and in specific rooms (a meeting room) or types of buildings (a movie theater). Additionally, a rate of movement of the WTRU can be used to determine whether the user is in a moving vehicle. Other environmental information includes the time of day, week and year. To illustrate, it may be desirable to automatically switch the WTRU 10 to vibrate mode, during working hours.

The WTRU uses the environmental inputs to classify the environment into multiple categories, (step 32). One classification of environments is by the sensitivity of the environment to ringer noise, such as “quiet”, “low volume” and “high volume”. The “quiet” classification is used in environments where a ring is undesirable, such as in a movie theatre, or extremely noisy environment. The “low volume” classification is used for environments where a low volume ring is desired, such as in an area with low noise or an office setting. The “high volume” classification is used for environments where a high volume ring is desired, such as around moderate noise or machinery.

Another classification of environments is by environment type, such as “low volume”, “moderate volume” and “high volume”. In a “low volume” environment, the desired annunciator may be a low volume ring. In a “moderate volume” environment, a high volume ring may be used. In a “high volume” environment, a quiet annunciator is used.

Based on the implementation and the WTRU capabilities, the classification may be based on the ambient noise volume, other noise characteristics and/or position and movement information. To illustrate, it may be desirable for the WTRU 10 to use a vibration based annunciator at a concert (as detected based on the movie theatre position and detecting music). By contrast, it may be desirable to use a ringer while listening to the radio in a moving car (as detected based on movement and detected music).

Based on the identified category, the call annunciator controller 14, 21 selects a call annunciator, (step 34). The call annunciator types include various ring volume levels, ring types/tones and silent call annunciators. The silent annunciators include vibration based and light based. The selected annunciator is one that will be most likely noticed by the user of the WTRU 10, resulting in less missed calls.

To illustrate, if general voice or background noises occurs above a predetermined level indicating a noisy environment, the WTRU 10 switch to a higher volume ringer or quiet (vibration) mode. If a large proportion of the sound is analyzed as being music, indicating that ringing is undesired (such as the user being at a concert or musical), the WTRU 10 switches to a quiet mode (such as vibration mode). If the noise includes mechanical sounds, a high volume mode is used to overcome the ambient noise.

In an alternate embodiment, the user is prompted to accept or reject the change in call annunciation. To illustrate, a change from a “quiet” environment to a “high volume” environment is detected. The user is prompted to either accept the mode change or reject it. Thus, for example, at a movie, the user can receive a vibration, and respond by locking the WTRU 10 into a “vibrate” mode, despite the fact that sounds from a movie soundtrack can vary from a music soundtrack to noise approximating an environment in which noisy ringer sounds would otherwise be acceptable (outside a movie theater). Typically, in embodiments without user prompting, the user can manually override the automated annunciator settings.

In one configuration, the WTRU 10 can be set to a mode in which incoming calls are automatically screened. The WTRU 10 is configured to take into account the incoming phone number or other caller specific information to determine whether to apply the above techniques. The calls can be categorized into multiple categories. One embodiment uses two categories: “high priority” and “others”, although more categories can be used, such as “medium priority”, “low priority” and “unknown”.

The classification can be in accordance with a database such as an address book on the WTRU 10, from an external source (such as network based). If the call is given a “high priority” classification, the WTRU 10 provides a corresponding “high priority” ring in the manner selected by the user. Particular calls can be pre-identified, either by the characteristics of the call (e.g., phone number indicated by CLID), by caller response to a query (such as depressing a key or voice response), or by a “punch through” signal provided by the caller. The “punch through” signal may be generated in response to the caller inputting a specified code. The particular criteria for classification are a matter of design choice and user selection.

In addition, to allocating differing rings to each classification, some classifications may be blocked or directly sent to voice mail. To illustrate, when a wireless user is at a conference, the user may only want to accept “high priority” calls and allow the others to pass to voicemail.

To illustrate, a user assigns telephone numbers to a “high priority” and a “low priority category”. Additionally, the user may have a specified “punch through code”. If the user was in an important meeting, only the “high priority” calls would be permitted through a first level of screening. For a received “high priority” call, the caller may be asked to input the “punch through” code in the case of an emergency. In this situation, only a “high priority” caller inputting the “punch through” code will cause the WTRU 10 to produce a “high priority” ring.

The use of the query is desirable in some situations, since the caller generally does not know the particular circumstances of the user of the WTRU 10. Therefore, a friend may be calling to “chat” or discuss issues of general priority while the user of the WTRU 10 is engaged in an activity in which answering the call would be inappropriate to the circumstances as indicated by the sensed environment. The ability to classify calls has a further advantage in jurisdictions, which permit unsolicited commercial calls to cell phones. By blocking calls which are not in user defined classes, the user can selectively avoid being notified of calls from unknown sources such as unsolicited commercial calls.

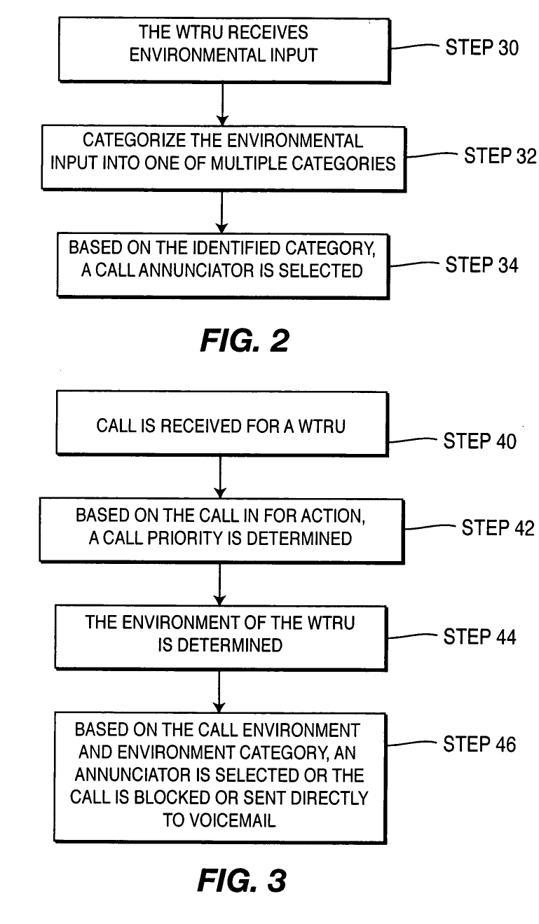

FIG. 3 is a flow chart for using caller screening in addition to environmental-aware annunciation. Initially, a call is received for a WTRU 10, (step 40). Based on information associated with the call, the call is provided a call priority, out of a set of multiple priorities, (step 42). The environment of the WTRU 10 is also categorized, (step 44). Based on both the call priority and the environment categorization, an annunciator is selected or whether the call should be blocked or sent to voice mail is determined, (step 46).

1. A method for selecting a call annunciator for use with a wireless transmit/receive unit (WTRU), the method comprising:
the WTRU receiving environmental input and categorizing the environmental input into one of a plurality of categories;
based on the one environmental input category, selecting a call annunciator type out of a plurality of call annunciator types; and
annunciating a received call using the selected call annunciator type.

2. The method of claim 1 wherein the receiving environmental input comprises analyzing sounds in an environment surrounding the WTRU and basing the one environmental input category on the analyzed sounds.

3. The method of claim 1 wherein the receiving environmental input comprises receiving position information and basing the one environmental input category on the received position information.

4. The method of claim 1 wherein the receiving environmental input comprises receiving time information and basing the one environmental input category on the received time information.

5. The method of claim 1 wherein the plurality of categories correspond to desired used annunciator for the environment category.

6. The method of claim 1 further comprising receiving call information and basing the one environmental input category on the call information.

7. The method of claim 6 further comprising prioritizing a call based on the call information and the basing the one environmental input category uses the call prioritization.

8. The method of claim 7 wherein the annunciator types include a non-annunciated type.

9. The method of claim 8 wherein the non-annunciated type is performed by blocking the call.

10. The method of claim 8 wherein the non-annunciated type is performed by sending the call to voice mail.

11. A method for selecting a call annunciator for use with a wireless transmit/receive unit (WTRU), the method comprising:
the WTRU receiving environmental input and categorizing the environmental input into one of a plurality of categories;
receiving a call and associated call information;
prioritizing the call based on the call information;
based on the one environmental input category and the call prioritization, selecting a call annunciator type or non-call annunciator type; and
performing actions in response to the selected call or non-call annunciator type.

12. The method of claim 11 wherein the non-call annunciator type includes blocking the call.

13. The method of claim 11 wherein the non-call annunciator type includes sending the call to voice mail.

14. A wireless transmit/receive unit (WTRU) comprising:
a radio frequency section for communication with a wireless network;
a processor for receiving environmental input and categorizing the received environmental input into one of a plurality of categories;
an annunciator controller for selecting an annunciator type based on the one environmental input category; and
an annunciator for annunciating a call based on the selected annunciator type.

15. The WTRU of claim 14 further comprising a user input/out put devices for receiving environmental sounds and using the received environmental sounds as an environmental input.

16. The WTRU of claim 14 further comprising a positing device for determining a position of the WTRU and using the determined position as an environmental input.

17. A wireless transmit/receive unit (WTRU) comprising:
means for communication with a wireless network;
processor means for receiving environmental input and categorizing the received environmental input into one of a plurality of categories;
means for selecting an annunciator type based on the one environmental input category; and
means for annunciating a call based on the selected annunciator type.

18. The WTRU of claim 17 further comprising means for receiving environmental sounds and wherein the received environmental sounds are used as an environmental input.

19. The WTRU of claim 17 further comprising a means for determining a position of the WTRU and using the determined position as an environmental input.

20. An integrated circuit for use in a wireless transmit/receive unit (WTRU) comprising:
an input configured to receive a baseband version of communications received from a wireless network;
a processor for receiving environmental input and categorizing the received environmental input into one of a plurality of categories; and
an annunciator controller for selecting an annunciator type based on the one environmental input category.
